(19) United States
(12) Patent Application Publication
(10) Pub. No.: US 2009/0095667 A1
(43) Pub. Date: Apr. 16, 2009

(54) STEEL DRAIN WITH AUTOMATIC CLOSER

(75) Inventors: William Shipley, Greenville, TX (US); Shelia Heller, Greenville, TX (US); John Henry, Greenville, TX (US)

Correspondence Address: ANDERSON, LEVINE & LINTEL L.L.P., 14785 PRESTON ROAD, SUITE 650, DALLAS, TX, 75254, US

(73) Assignee: EAST CREEK CORPORATION, Caddo Mills, TX (US)

(21) Appl. No.: 12/251,269

(22) Filed: Oct. 14, 2008

Related U.S. Application Data
(60) Provisional application No. 60/979,701, filed on Oct. 12, 2007.

(51) Int. Cl. C02F 1/40; C02F 103/32

(52) U.S. Cl. 210/165

(57) ABSTRACT

Cleaning operations involving steam and flushing with water produce runoff that flows into drains installed in factory floors. Allowing bulky materials to flow into and plugging factory drains creates floor flooding conditions, production line shutdown and loss of time and money. These conditions can occur when strainer baskets are removed from drains. A drain facilitated with a drain closer prevents flow of bulky materials into drains and subsequent plugging. The drain closer is activated with a modified strainer basket such that removal of the basket closes the drain preventing inflow of bulky materials.

### CROSS-REFERENCE TO RELATED APPLICATIONS

This application claims the benefit of the filing date of copending provisional application U.S. Ser. No. 60/979701, filed Oct. 12, 2007, entitled “STEEL DRAIN WITH AUTOMATIC CLOSER”, which is incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to drains and, more particularly, to a drain which automatically closes when its strainer basket is removed.

2. Description of the Related Art

Equipment in commercial bakeries often requires periodic sanitation operations. Sanitation processes include cleaning with steam and flushing with water to remove the debris accumulated on the machines from the baking process. The flushed debris flows into floor drains and can include, along with the materials called “fines”, larger materials having substantial mass. Larger bulkier materials will plug the holes in the drain's strainer basket which is often removed by the workers.

A significant problem is created when drain strainer baskets are removed. Basket removal allows materials of greater mass than the drains can accommodate to flow into and plug the drains and attached pipes. With the strainer basket in place, nothing larger in mass than the basket's small holes can flow into the drains. When a basket is removed for cleaning, however, larger materials can flow through the drain and pipes, which may result in clogs. Occassionally, workers may intentionally remove the strainers to eliminate the chore of cleaning the strainers. Allowing long term flow of unstrained water through the plumbing system can cause serious problems.

Therefore, a need has arisen for an improved drain and strainer device.

### BRIEF SUMMARY OF THE INVENTION

The present invention provides a self-closing drain assembly comprising a drain and a strainer for preventing particles of a predetermined size from flowing therethrough, where the strainer includes a basket and an actuator protruding from the basket. A closure assembly is coupled to the drain, which opens when the actuator is engaged in the closure assembly and closes when the actuator is removed from the closure assembly.

The present invention provides significant advantages over the prior art. First, the drain is automatically closed when the drain basket is removed, preventing unstrained water from flowing through the drain. Second, the workers cannot flush anything larger than the basket's holes down the drains when the drain basket is in place. Third, workers cannot easily open the closure assembly to improperly drain unstrained water.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1a illustrates a strainer basket with closer actuator;

FIG. 1b illustrates a top view of a funnel drain with a drain closer mechanism, with the strainer basket with actuator removed and the drain closer closed;

FIG. 1c illustrates a cross sectional side view showing the funnel drain with the actuator removed from the closer mechanism such that the closer is in an closed state;

FIG. 1d illustrates a cross sectional side view showing the funnel drain with the actuator engaged in the closer mechanism such that the closer is in an open state;

FIG. 2a illustrates a top view of the closer mechanism;

FIG. 2b illustrates a bottom view of the closer mechanism;

FIG. 2c illustrates a side view of the closer mechanism.

### DETAILED DESCRIPTION OF THE INVENTION

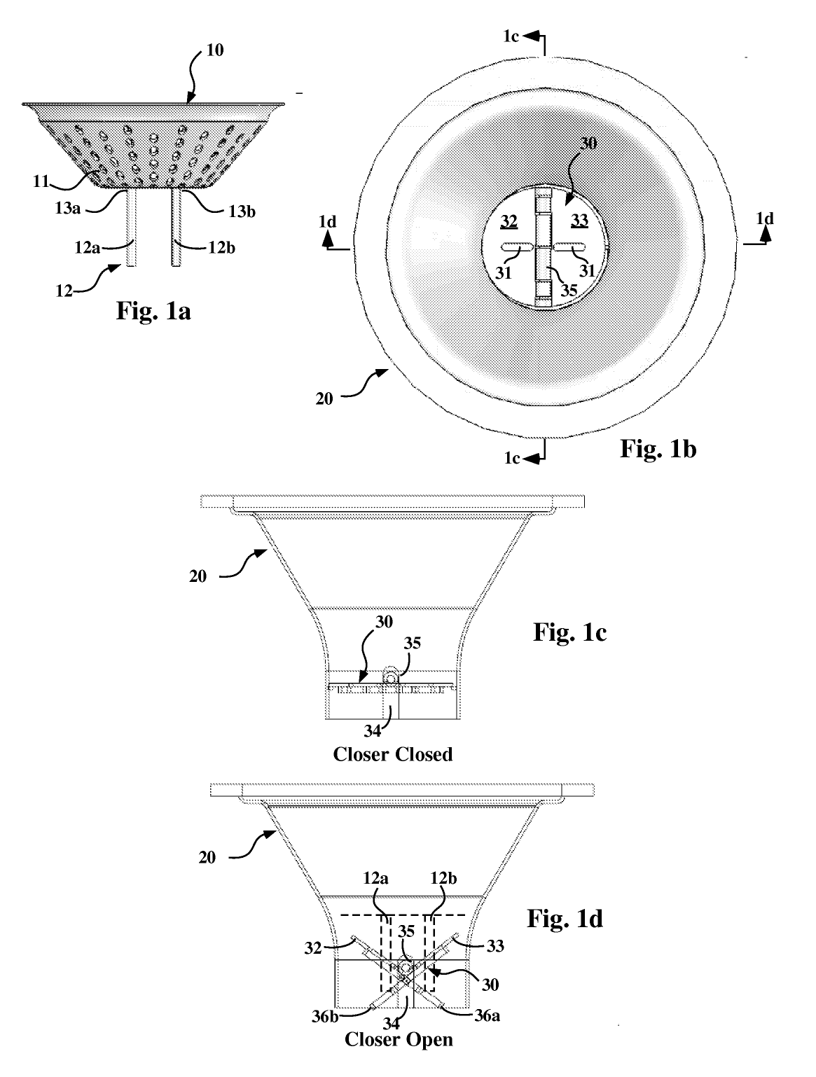

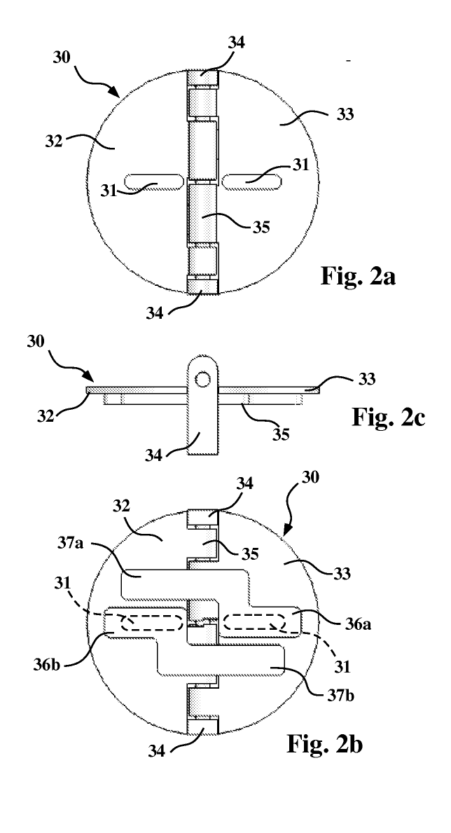

The present invention is best understood in relation to FIGS. 1-2 of the drawings, like numerals being used for like elements of the various drawings.

FIG. 1a illustrates a strainer basket 10 with straining portion 11 and an actuator 12 which controls the state of a closer mechanism on a drain. The actuator 12 is coupled to the straining portion 11. Actuator 12 includes pins 12a and 12b that are coupled to the straining portion 11 at welds 13a and 13b. The welds 13a and 13b can be polished to prevent sites that might harbor bacteria.

FIG. 1b illustrates a top view of a funnel drain 20 assembled with the drain closer 30 assembly in position at the bottom of the funnel drain cone. When the strainer 10 with actuator 12 is removed, the closer mechanism 30 closes (FIG. 1c), preventing unstrained water from flowing therethrough. When the pins 12a-b of actuator 12 engage with the drain closer mechanism 30 through slots 31, the closer mechanism 30 opens (FIG. 1d) to allow strained water and debris to flow therethrough.

With the drain strainer 10 removed from the funnel drain 20, the drain closer 30 blocks the main flow of liquids and any accumulated larger materials from flowing into the drains. Any accumulation of the larger materials would be removed from the flow before allowing the drain closer to be opened.

FIG. 1c illustrates the position of the drain closer at the junction of the funnel drain cone and the drain connection sleeve. When the pins 12a and 12b are removed from slots 31, the stopper halves 32 and 33 are in a horizontal plane and thus block water from passing through the drain 10. It would be difficult for a worker to temporarily open the closer mechanism 30 without placing the straining basket 10 in the drain 20. Thus, bypassing the safeguard of the straining basket is difficult.

FIG. 1d illustrates the closer 30 being opened by the closer actuator assembly 12. In this view only the actuator assembly parts are shown for clarity. In actual use, the drain filter basket 11 to which the actuator assembly 12 is attached would also be in place above the actuator 12.

When the drain filter basket 10 is inserted into the drain 20, pins 12a and 12b of the actuator 12 protrude through slots 31, pressing down on tabs 36a and 36b, respectively, which lie below stopper halves 32 and 33. The pressure on the tabs 36a-b causes the stopper halves 32 and 33 to rotate around hinge pin 35, causing the stopper halves 32 and 33 to point upwards, opening the drain closer 30 to allow strained water to pass through the drain. The basket 11 prevents materials of a size greater than the holes in the filter basket to flow through the drain 20.

FIGS. 2a and 2b illustrate the details of the drain closer assembly 30. Assembled drain closer 30 parts include stopper halves 32 and 33, hinge tabs 36a-b, pivot lugs 34a-b and hinge pin 35. Drain closer assembly 30 is assembled and welded on the drain connection sleeve using pivot lugs 34a-b. The welds can be polished to prevent sites that might harbor bacteria.

When the modified drain strainer actuator is properly oriented in the funnel drain, the actuator pins 12a-b push down on the closer hinge tabs 36a-b through slots in the stopper halves 32 and 33. Tab 36a is attached to stopper half 32 at weld 37a and tab 36b is attached to stopper half 33 at weld 37b. Stopper halves 32 and 33 are coupled to opposite sides of hinge pin 35. When the pins are disposed through the slots 31 and press down on the hinge tabs 36a and 36b, the tab apply leverage to their respective stopper halves 32 and 33, causing the halves to rotate upward about the hinge pin 35, as shown in FIG. 1d. When the drain strainer 10 is removed the stopper halves 32 and 33 drop back into the closed position and prevent flow of bulky materials into the drain.

The present invention provides significant advantages over the prior art. For example, if a worker removes the strainer 10, for example to remove debris from the strainer basket 11, the drain closer 30 will close and unstrained water will be prevented from passing through the drain 20 until the strainer is replaced. Further, a worker cannot intentionally remove the strainer to avoid the effort in cleaning the strainer.

1. A self-closing drain assembly comprising:
a drain;
a strainer for preventing particles of a predetermined size from flowing therethrough, said strainer including a basket and an actuator protruding from the basket;
a closure assembly coupled to the drain, which opens when the actuator is engaged in the closure assembly and closes when the actuator is removed from the closure assembly.

2. The self-closing drain of claim 1 wherein the closure assembly comprises:
first and second stopper halves coupled to a hinge, each stopper half having a hole formed therethrough for receiving the actuator;
first and second tabs attached to respective ones of the first and second stopper halves, wherein the first tab is exposed by the hole in the second stopper half and the second tab is exposed by the hole in the first stopper half.

3. The self-closing drain of claim 2 wherein the actuator includes first and second pins for protruding through the holes in the first and second stopper halves when the strainer is properly placed in the drain, such that the first pin presses against the second tab and the second pin presses against the first tab.
